(19) United States
(12) Patent Application Publication
(10) Pub. No.: US 2013/0256068 A1
(43) Pub. Date: Oct. 3, 2013

(54) DISC BRAKE DEVICE

(71) Applicant: HONDA MOTOR CO., LTD, Tokyo (JP)

(72) Inventors: Takahiro Hazeki, Wako-shi (JP); Akihiko Koike, Wako-shi (JP)

(73) Assignee: HONDA MOTOR CO., LTD, Tokyo (JP)

(21) Appl. No.: 13/837,787

(22) Filed: Mar. 15, 2013

(30) Foreign Application Priority Data
Mar. 29, 2012 (JP) 2012-075679

(51) Int. Cl. F16D 55/226

(52) U.S. Cl. CPC F16D 55/226
USPC 188/72.4

(57) ABSTRACT

A disc brake device for applying brake to wheels by pressing a disc rotor between pads, the disc brake device includes: pads disposed at a position to press the disc rotor; a first piston which can press one pad; a cylinder which slidably supports the first piston; and a body frame which can press the other pad, the body frame having: a pad connection portion which connects to the other pad in a push-pull manner; and a sliding portion which is slidably supported by the cylinder. The disc brake device includes a caliper bracket which supports the pads not to limit a movement in the axial direction, but to limit a movement in any direction other than the axial direction on disc-rotor-rotating-in and disc-rotor-rotating-out sides of the disc brake device, the caliper bracket being provided integrally with the cylinder and separated from the pad connection portion.

### CROSS REFERENCES TO RELATED APPLICATIONS

The present application claims priority under 35 U.S.C. $119 to Japanese Patent Application No. 2012-075679, filed Mar. 29, 2012, entitled “Disc Brake Device.” The contents of this application are incorporated herein by reference in their entirety.

### TECHNICAL FIELD

The present disclosure relates to a disc brake device for applying brake on a vehicle by pressing a disc rotor between a pair of pads.

### BACKGROUND

There is known a disc brake device having a collet type caliper as a disc brake device for applying brake on a vehicle by pressing a disc rotor between a pair of pads. In the collet type caliper, one piston for pressing the pads is disposed in one cylinder. Thus, in order to press the disc rotor between a pair of pads (an inner pad and an outer pad), hydraulic fluid is supplied between the piston in the cylinder and the caliper body which is integrated with the cylinder, so that the piston presses the inner pad, the caliper body presses the outer pad, and thus the brake disc is pressed between the pads.

However, because rollback of the piston with respect to the cylinder occurs due to the seal when the brake is released in the collet type caliper, the inner pad near the piston is separated from the disc rotor, however, the outer pad near the caliper body is not separated from the disc rotor and may be dragged.

Thus, a disc brake device has been proposed, which includes a caliper in which two pistons for pressing the pads are disposed in one cylinder (for example, see Japanese Examined Patent Application Publication No. 48-21031). In the caliper, one piston presses the inner pad, and the other piston presses the outer pad via a yoke, so that the brake disc is pressed between the pads. For this reason because rollback of both pistons with respect to the cylinder occurs due to the seal when the brake is released, the inner and outer pads are separated from the disc rotor, and thus dragging of the outer pad can be prevented.

### SUMMARY

In the disc brake device, when brake is applied, a braking force acts on the inner pad and the outer pad due to dragging of the pads along the disc rotor in rotation. Particularly, the braking force applied to the outer pad is transmitted to the corresponding piston via a body frame (corresponding to the caliper body and the yoke), and thus performance of sealing between the piston and the cylinder is reduced. Because the aforementioned rollback occurs due to the sealing performance, when the sealing performance is reduced, the rollback becomes difficult to occur.

Thus, in Japanese Examined Patent Application Publication No. 48-21031, the disc brake device is designed such that although the body frame receives a braking force, the braking force is not transmitted from the body frame to the corresponding piston. However, the above design causes friction, and a pressing force transmitted from the corresponding piston to the outer pad via the body frame may be reduced. Considering this problem, it is desirable that the braking force applied to the outer pad be not transmitted to the body frame, that is to say, it is desirable that the body frame be not deformed by the braking force applied to the outer pad.

Thus, the present disclosure provides a disc brake device which can reduce deformation of the body frame caused by the braking force applied to the outer pad when the brake is applied.

The present disclosure provides a disc brake device including: a disc rotor which rotates with a wheel; a pair of pads disposed at a position so as to press the disc rotor; a first piston which can press one of the pads against the disc rotor; a cylinder which supports the first piston slidably in an axial direction; and a body frame which can press the other of the pads against the disc rotor. The body frame includes: a pad connection portion which connects to the other of the pads in a push-pull manner; and a sliding portion which is supported by the cylinder slidably in the axial direction and creates a space between the sliding portion and the first piston, the space serving as a hydraulic pressure chamber to which hydraulic fluid is supplied; the disc brake device which applies a brake to the wheel by pressing the disc rotor between the pair of pads further comprises a caliper bracket which supports the pair of pads so as not to limit a movement of the pair of pads in the axial direction on a rotating-in side and a rotating-out side of the disc rotor, but to limit a movement of the pair of pads in any direction other than the axial direction, the caliper bracket being provided integrally with the cylinder and separated from the pad connection portion.

According to the above, when hydraulic fluid is supplied to the hydraulic pressure chamber, the first piston and the sliding portion of the body frame are pressed in the respective outward directions of the axis of the cylinder. Accordingly, the first piston presses one pad (inner pad) to the disc rotor, the pad connection portion of the body frame presses the other pad (outer pad) to the disc rotor as the sliding portion moves, and thus the disc rotor is pressed between a pair of the pads, and the brake is applied to the wheel.

In addition, when hydraulic fluid is discharged from the hydraulic pressure chamber, a pair of the pads are separated from the disc rotor because rollback of the first piston and the sliding portion with respect to the cylinder occurs due to respective seals, and thus dragging of a pair of the pads, particularly, dragging of the outer pad can be prevented.

The caliper bracket does not limit the movement of a pair of the pads in the axial direction of the disc rotor, but supports the pads so as to limit the movement of the pads in any direction other than the axial direction of the disc rotor, and thus the braking force can be received by the caliper bracket without preventing pressing action of the pair of pads against the disc rotor. Because the caliper bracket supports the pair of pads at two positions on disc-rotor-rotating-in side (“rotating-in side”) and disc-rotor-rotating-out side (“rotating-out side”) of the disc brake device, the braking force can be reliably received by the caliper bracket. Therefore, the body frame almost does not receive the braking force, and thus no backlash, deformation, and distortion occurs in the body frame, and the rollback of the seal can be ensured. In addition, the caliper bracket is separated from (the pad connection portion of) the body frame, and thus the brake input is not transmitted from the caliper bracket to the body frame.

In the present disclosure, it is preferable that the caliper bracket includes: a pair of slide pins which penetrate through a pair of pad plates for fixing the pair of pads in the axial direction on the rotating-in side and the rotating-out side of the disc rotor with respect to the pads; and first and second bridge portions which connect both ends of each of the slide pins.

According to the above, the braking force of the pads to the caliper bracket can be first received by the slide pin of the caliper bracket, and subsequently can be received by the first and second bridge portions. The braking force received by the first and second bridge portions can be then received by the cylinder without being transmitted to the body frame. Because the first and second bridge portions supported by the cylinder can firmly support the slide pin, action of a drawing-in force to the disc rotor on the rotating-in side of the pads, what is called the self servo effect can be suppressed, and thus the dragging can be prevented.

In the present disclosure, it is preferable that respective ends of the pair of slide pins, which are located on an opposite side to the cylinder are connected to each other by a first tie bar, and the first tie bar is separated from the pad connection portion.

According to the above, respective ends of a pair of slide pins are connected to each other by the first tie bar, and thus both slide pins offset a deflecting force with each other, and the deflection of the slide pins can be reduced. Because the axes of the both slide pins can be maintained in parallel, the self servo effect can be reduced.

In the present disclosure, it is preferable that the caliper bracket has a second tie bar which connects respective ends of the pair of slide pins, which are located on a cylinder side of the slide pins, the second tie bar being supported by the cylinder, and the first tie bar and the second tie bar are connected via the first and second bridge portions.

According to the above, the slide pin, to which the braking force is applied from the pads when the brake is applied, can be reliably received by a pair of the first and second bridge portions, the first tie bar, and the second tie bar which form a quadrilateral.

In the present disclosure, it is preferable that the body frame has third and fourth bridge portions which connect the pad connection portion and the sliding portion over the disc rotor, the pad connection portion is disposed at a position which is closer to an axis of the disc rotor than the first tie bar, and a pair of the third and fourth bridge portions are disposed at outer positions in a circumferential direction of the disc rotor with respect to the first and second bridge portions.

According to the above, the pad connection portion and the third and fourth bridge portions of the body frame can be spaced away from the first tie bar and the first and second bridge portions of the caliper bracket, and thus the braking force can be prevented from being transmitted to the body frame.

In the present disclosure, it is preferable that the body frame has the third and fourth bridge portions which connect the pad connection portion and the sliding portion over the disc rotor, and the sliding portion has a second piston which is supported by the cylinder slidably in the axial direction and faces the first piston, and a connection portion which is connected to the second piston or provided integrally with the second piston, and also connected to the third and fourth bridge portions.

According to the above, when hydraulic fluid is supplied to the hydraulic pressure chamber, the body frame can be moved by receiving the hydraulic pressure with the second piston, and thus the other pad (outer pad) can be pressed against the disc rotor. In addition, because the second piston and the sliding portion of the body frame are connected or integrally provided, rollback due to the seal of the second piston can be reliably transmitted to the body frame when the brake is released, and thus the outer pad can be separated from the disc rotor.

In the present disclosure, it is preferable that the sliding portion is supported on an outer circumference of the cylinder slidably in the axial direction.

According to the above, a single piston structure may be used, and thus cost performance is excellent.

In the present disclosure, it is preferable that the body frame has a pad locking portion which engages part of an outer end of the pad plate with respect to the pads to the pad connection portion, so that a movement of the other pad plate securing the other pad in the axial direction is coordinated with the pad connection portion, but a movement of the other pad plate in any direction other than the axial direction is not coordinated with the pad connection portion.

According to the above, the other pad (the outer pad and the pad plate) has a slight play for rotation movement (play on the pad connection portion side) with respect to a position of the outer end of the pad plate, the position being the center of the play. When the brake is applied, the pad connection portion of the body frame is made to come into contact with and pressed against the other pad (the outer pad and the pad plate), and friction may occur on the contact surface. The occurrence of friction causes the braking force to be transmitted to the pad connection portion from the other pad (the outer pad and the pad plate). Because the caliper bracket also allows the movement of the pads in the axial direction, it is possible that a slight play (play on the caliper bracket side) is created in the direction of the rotation, which is a direction other than the axial direction even though the movement of the pads is limited in any direction other than the axial direction. Specifically, the created play is probably the one in the slide pin and the pad plate through which the slide pin penetrates. However, the transmission of the braking force to the pad connection portion can be prevented by enabling the outer pad and the pad plate to move because of the play provided on the pad connection portion side, and by enabling the braking force, which is transmitted to the outer pad and the pad plate, to be transmitted to the caliper bracket (slide pin) by eliminating a play on the caliper bracket side. Accordingly, transmission of the braking force to the pad connection portion can be reduced.

The present disclosure provides a disc brake device including: a disc rotor which rotates with a wheel; a pair of pads disposed at a position so as to press the disc rotor; a first piston which can press one of the pads against the disc rotor; a cylinder which supports the first piston slidably in an axial direction; and a body frame which can press the other of the pads against the disc rotor. The disc brake device which applies a brake to the wheel by supplying hydraulic fluid to a hydraulic pressure chamber which is demarcated by the cylinder and the first piston and pressing the disc rotor between the pair of pads further comprises a caliper bracket which supports the pair of pads so as not to limit a movement of the pair of pads in the axial direction, but to limit a movement of the pair of pads in any direction other than the axial direction on the rotating-in side and the rotating-out side of the pads, the caliper bracket being separated from the body frame and supported by a vehicle body.

According to the above, when hydraulic fluid is supplied to the hydraulic pressure chamber, the first piston presses the one pad (inner pad) against the disc rotor, and the body frame presses the other pad (outer pad) against the disc rotor, and thus the disc rotor is pressed between a pair of the pads, and the brake is applied to the wheel.

The caliper bracket does not limit the movement of a pair of the pads in the axial direction of the disc rotor, but supports the pads so as to limit the movement of the pads in any direction other than the axial direction of the disc rotor, and thus the braking force can be received by the caliper bracket without preventing pressing action of the pair of pads against the disc rotor. Therefore, the body frame almost does not receive the braking force, and thus no backlash, deformation, and distortion occurs in the body frame, and the rollback of the seal in the cylinder and the first piston can be ensured. In addition, the caliper bracket is separated from the body frame and supported on the vehicle body, and thus the brake input is not transmitted from the caliper bracket to the body frame.

### BRIEF DESCRIPTION OF THE DRAWINGS

The advantages of the disclosure will become apparent in the following description taken in conjunction with the following drawings.

FIG. 1 is a perspective view of a disc brake device according to a first embodiment of the present disclosure.

FIG. 2 is a vertical cross-sectional perspective view of the disc brake device according to the first embodiment of the present disclosure.

FIG. 3 is an exploded perspective view of the disc brake device according to the first embodiment of the present disclosure.

FIG. 4A is a perspective view of a pad locking portion (wire spring); FIG. 4B is a perspective view from below of a body frame; and FIG. 4C is a perspective view from above of the body frame.

FIG. 5 is a plan view of the disc brake device according to the first embodiment of the present disclosure.

FIG. 6 is a cross-sectional view taken along a line VI-VI in FIG. 5.

FIG. 7 is a cross-sectional view taken along a line VII-VII in FIG. 5.

FIG. 8 is a cross-sectional view of a disc brake device according to a second embodiment of the present disclosure.

FIG. 9 is a perspective view of the disc brake device according to the second embodiment of the present disclosure.

FIG. 10 is a perspective view of the body frame.

### DETAILED DESCRIPTION

Next, the embodiments of the present disclosure will be described in detail with reference to the drawings as needed. Common components between the figures are labeled with the same reference symbol, and duplicated description is omitted.

### First Embodiment

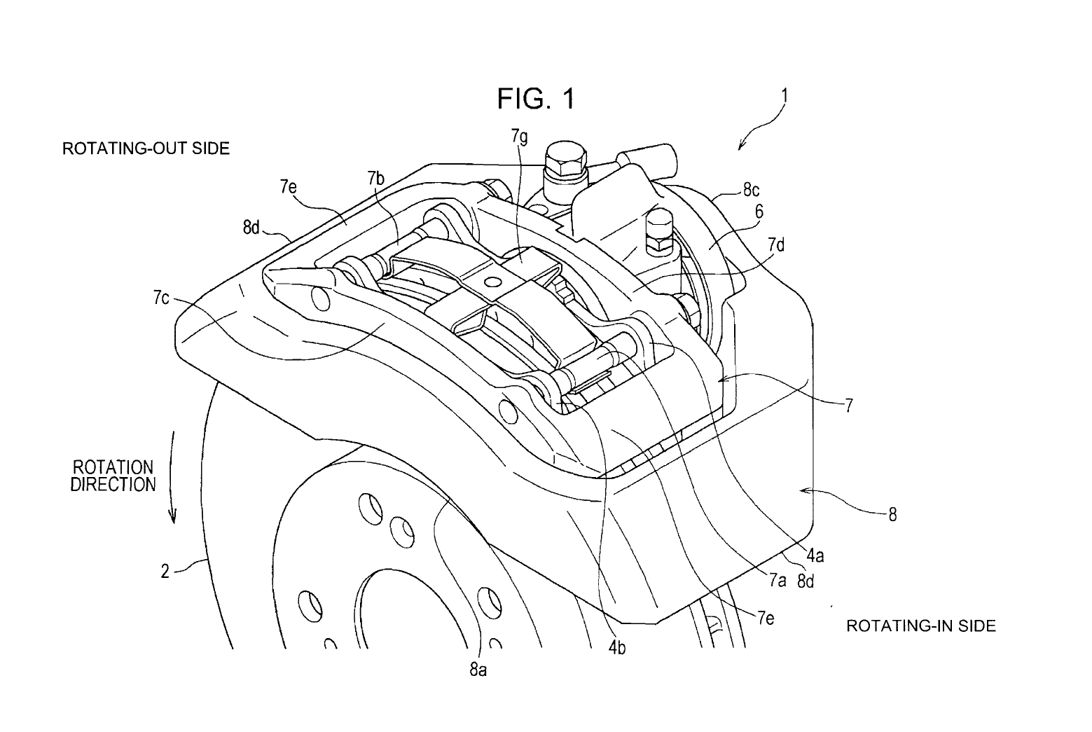

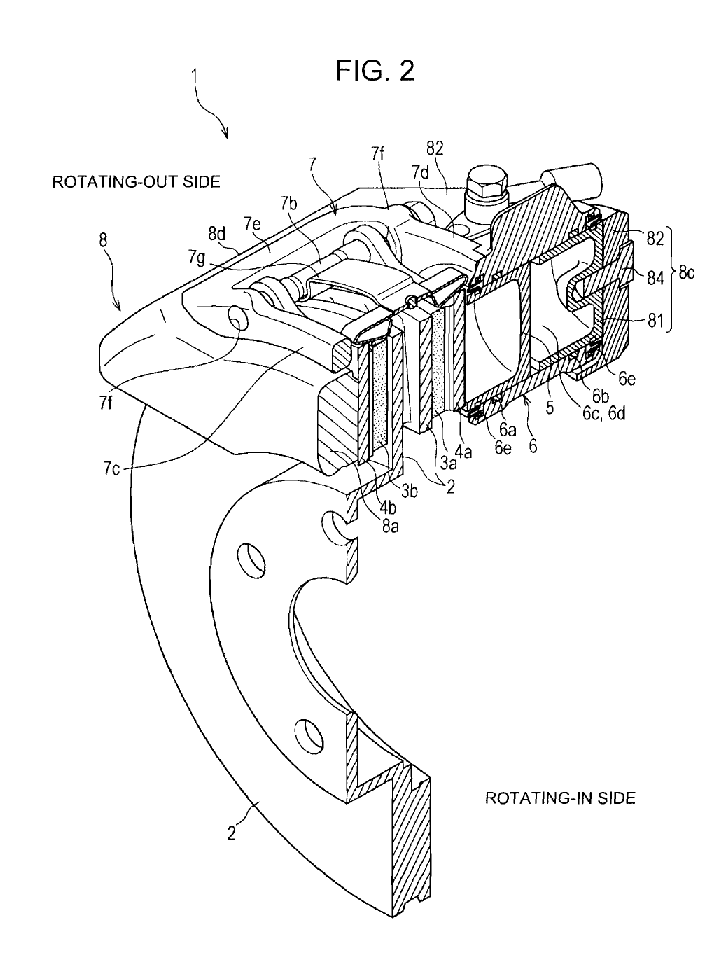

FIG. 1 illustrates a perspective view of a disc brake device 1 according to a first embodiment of the present disclosure; and FIG. 2 illustrates a vertical cross-sectional perspective view of the disc brake device 1. As illustrated in FIG. 2, the disc brake device 1 includes a disc rotor 2 which rotates with a wheel (not illustrated); a pair of pads 3a, 3b which are disposed at positions so as to press the disc rotor 2; a first piston 5 which can press an inner pad 3a, which is one of the pads 3a, 3b, against the disc rotor 2; a cylinder 6 which supports the first piston 5 slidably in an axial direction; a body frame 8 which can press the outer pad 3b, which is the other of the pads 3a, 3b, against the disc rotor 2; and a caliper bracket 7 which supports the pads 3a, 3b, and is provided integrally with the cylinder 6.

The inner pad 3a is fixed to a pad plate 4a. The inner pad 3a and the pad plate 4a are connected to the first piston 5 in a push-pull manner. The first piston 5 is housed inside the cylinder 6. An urging portion (sealing member) 6a such as an O-ring is provided between the first piston 5 and the cylinder 6 so as to maintain liquid-tight sealing therebetween. A dust cover 6e is provided at an opening of the cylinder 6 near the first piston 5 so that dust does not enter between the first piston 5 and the cylinder 6.

The outer pad 3b is fixed to a pad plate 4b. The outer pad 3b and the pad plate 4b are connected to a pad connection portion 8a of the body frame 8 in a push-pull manner in which the outer pad 3b and the pad plate 4b may be pushed and pulled by the pad connection portion 8a.

The body frame 8 has the pad connection portion 8a, a sliding portion 8c, and a pair of second bridge portions (frame-side bridge portions) 8d which connect the pad connection portion 8a and the sliding portion 8c and extend over the disc rotor 2. As illustrated in FIG. 1, the body frame 8 is disposed in a frame shape along the outer periphery of the disc brake device 1. Because the disc rotor 2 normally rotates in a constant direction (constant rotational direction) corresponding to the traveling direction of a vehicle, the rotating-in side which enters between the pads 3a, 3b, and the rotating-out side which comes out therebetween can be defined in the disc rotor 2. The second bridge portions are provided on the both sides of the pad connection portion 8a and the sliding portion 8c (on the rotating-in side and the rotating-out side). The sliding portion 8c has a second piston 81 which is slidably supported by the cylinder 6 and faces the first piston 5, and a connection bar (connector) 82 which is rigidly secured (connected) to the second piston 81 via a bolt 84, or provided integrally with the second piston 81. The connection bar 82 is connected to the second piston 81 at the center, and is connected to the second bridge portions 8d at both ends. The second piston 81 is housed inside the cylinder 6. An urging portion (sealing member) 6b such as an O-ring is provided between the second piston 81 and the cylinder 6 so as to maintain liquid-tight sealing therebetween. The dust cover 6e is provided at an opening of the cylinder 6 near the second piston 81 so that dust does not enter between the second piston 81 and the cylinder 6.

The space which is demarcated by the cylinder 6, the first piston 5, and the second piston 81 is a hydraulic pressure chamber 6c. The hydraulic pressure chamber 6c is filled with hydraulic fluid 6d which is supplied from an external device, or discharged to the external device.

As illustrated in FIG. 1, the caliper bracket 7 has a pair of slide pins 7a, 7b which penetrate through a pair of the pad plates 4a, 4b in the rotational axis direction of the disc rotor 2 on the rotating-in side and the rotating-out side, respectively. The pair of slide pins 7a, 7b do not limit the movement of the pair of pad plates 4a, 4b (the pair of pads 3a, 3b) in the axial direction, but support the pads so as to limit the movement of the pads in any direction other than the axial direction. The slide pin 7a on the rotating-in side serves as a pull-anchor which supports the pads 3a, 3b by pulling the pair of pad plates 4a, 4b (the pair of pads 3a, 3b) against frictional force caused by the disc rotor, and the slide pin 7b on the rotating-out side serves as a push-anchor which supports the pads 3a, 3b by pushing the pair of pad plates 4a, 4b (the pair of pads 3a, 3b) against the frictional force. The caliper bracket 7 is provided integrally with an upper portion of one end of the cylinder 6 near the first piston 5. The caliper bracket 7 has a pair of first bridge portions (bridge portions on the bracket side) 7e, a first tie bar 7c, and a second tie bar 7d. The pair of first bridge portions are connected to both ends of the slide pins 7a, 7b, respectively to support the slide pins 7a, 7b. The first tie bar 7c connects the respective ends of the pair of slide pins 7a, 7b, which are on the opposite side to the cylinder 6. In addition, the first tie bar 7c connects the respective ends of the pair of first bridge portions 7e, which are on the opposite side to the cylinder 6. The second tie bar 7d connects the respective ends of the pair of slide pins 7a, 7b, which are on the cylinder side of the slide pins. The second tie bar 7d connects the respective ends of the pair of first bridge portions 7e, which are on the cylinder side of the slide pins. The second tie bar 7d is supported above one end of the cylinder 6. The pair of first bridge portions 7e, the first tie bar 7c, and the second tie bar 7d form a substantially quadrilateral frame structure in plan view. By adopting the frame-like structure, the structure can be made rigid. The caliper bracket 7 is considered to have a four-ladder structure, in which the pair of slide pins 7a, 7b and the pair of first bridge portions 7e are connected between the first tie bar 7c and the second tie bar 7d, and by adopting the four-ladder structure, the structure can be made rigid. The slide pins 7a, 7b can be stably supported with the ladder (frame) structure.

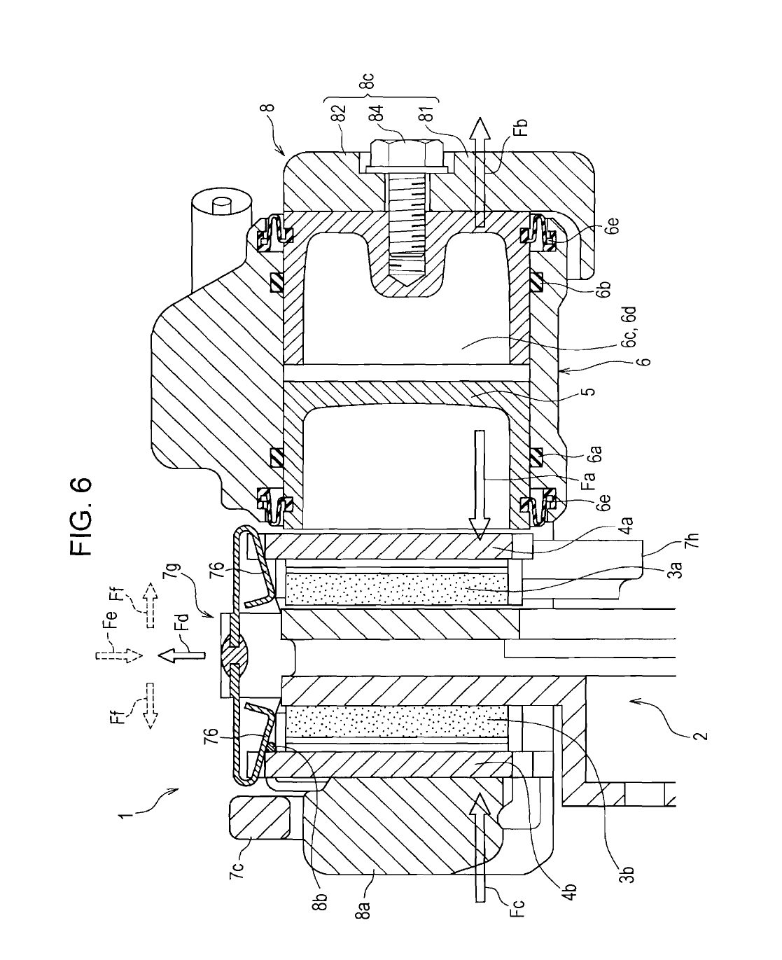

The caliper bracket 7 has an urging portion (return spring) 7g. As illustrated in FIG. 2, the return spring 7g is a plate spring which is in partial contact with respective upper portions of the pad plates 4a, 4b near the disc rotor 2, and urges the pad plates 4a, 4b in a direction away from the disc rotor 2. Dragging of the pads 3a, 3b can be prevented by the return spring 7g. The contact portion between the return spring 7g and the pad plates 4a, 4b is unevenly distributed on the top of the pad plates 4a, 4b. For example, the return spring 7g contacts the inner edge of the top surface of the pad plates 4a, 4b (see FIG. 6).

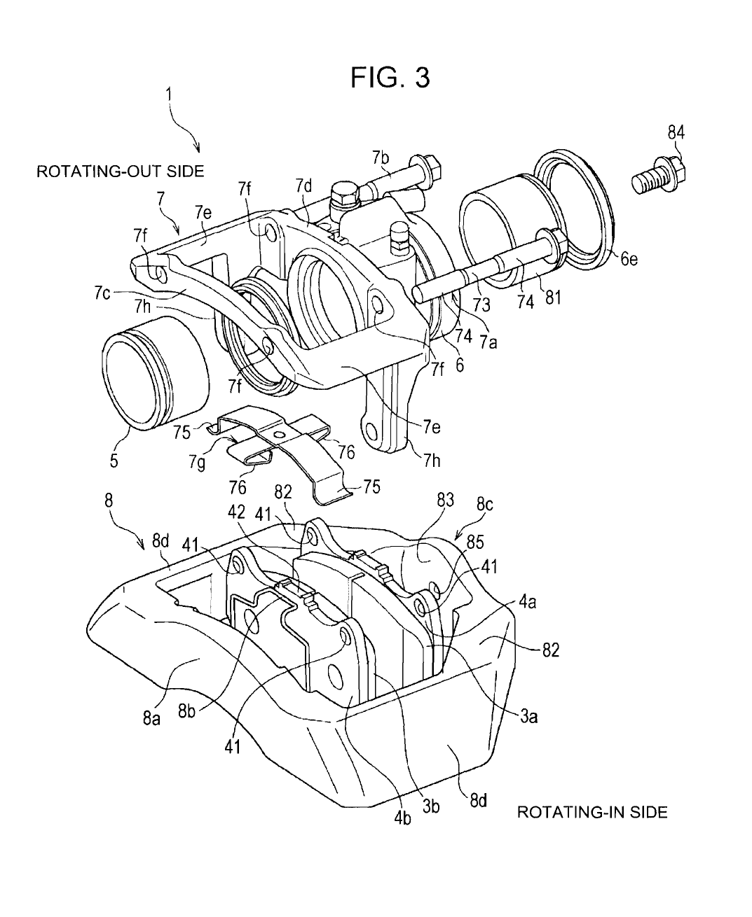

FIG. 3 illustrates an exploded perspective view of the disc brake device 1 according to the first embodiment of the present disclosure. The frame structure constituted by the pair of first bridge portions 7e, the first tie bar 7c, and the second tie bar 7d is formed integrally with the cylinder 6. The lower portions of the pair of first bridge portions 7e are integrally provided with a pair of knuckle supported portions 7h, respectively. Each knuckle supported portion 7h is connected to a knuckle portion of a vehicle body to support the main body of the caliper bracket 7, and in turn supports the main body of the disc brake device 1. Specifically, the cylinder 6 is supported by the second tie bar 7d of the caliper bracket 7. The first piston 5, the second piston 81, and the dust cover 6e are supported by the cylinder 6.

The respective ends of the slide pins 7a, 7b are fitted into slide pin supporting portions (holes) 7f, and supported by the frame structure constituted by the pair of first bridge portions 7e, the first tie bar 7c, and the second tie bar 7d. The slide pins 7a, 7b each include pad locking portions (body portions) 74 which are disposed at both ends of the slide pins 7a, 7b and fitted into the slide pin supporting portions (holes) 7f; and spring locking portion (neck portion) 73 which is disposed in the middle of the slide pins 7a, 7b, the spring locking portion having a diameter smaller than the diameter of the body portions 74. Contact of hook portions 75 of the return spring 7g with the neck portions 73 causes the return spring 7g to be positioned in the middle of the slide pins 7a, 7b, and supported. Inclined pressing portions 76 of the return spring 7g then come into partial contact with a projection portion 42 of the pad plates 4a, 4b at a position closer to the disc rotor 2.

The slide pins 7a, 7b penetrate through through-holes 41 disposed at the upper portions of the pad plates 4a, 4b on the rotating-in side and the rotating-out side, respectively, inside the frame structure. The pad plates 4a, 4b are suspendedly supported by the slide pins 7a, 7b at the pad locking portions (body portions) 74 which are disposed at the respective ends of the slide pins 7a, 7b. The inner pad 3a is attached to the pad plate 4a which supports the inner pad 3a. The outer pad 3b is attached to the pad plate 4b which supports the outer pad 3b.

The body frame 8 is supported at two positions which are the pad connection portion 8a and a pressure receiving surface 83 of the sliding portion 8c. The pressure receiving surface 83 is disposed in the middle of the connection bar 82 of the sliding portion 8c. In order to provide the first position for supporting the body frame 8, the bolt 84 is screwed into (rigidly connected to) the second piston 81 with the bolt 84 being inserted through a through-hole 85 which is disposed in the middle of the pressure receiving surface 83. Accordingly, the sliding portion 8c (the pressure receiving surface 83) of the body frame 8 is supported by the second piston 81. In the first embodiment, the connection bar 82 of the sliding portion 8c and the second piston 81 are joined together by the bolt 84, however, the first embodiment is not limited to this. The connection bar 82 and the second piston 81 may be connected (secured) to each other so as to move in the axial direction in a coordinated manner (sliding direction of the second piston 81). In order to provide the second position for supporting the body frame 8, the pad connection portion 8a of the body frame 8 is suspended from the pad plate 4b using a pad locking portion (wire spring) 8b, and thus is supported.

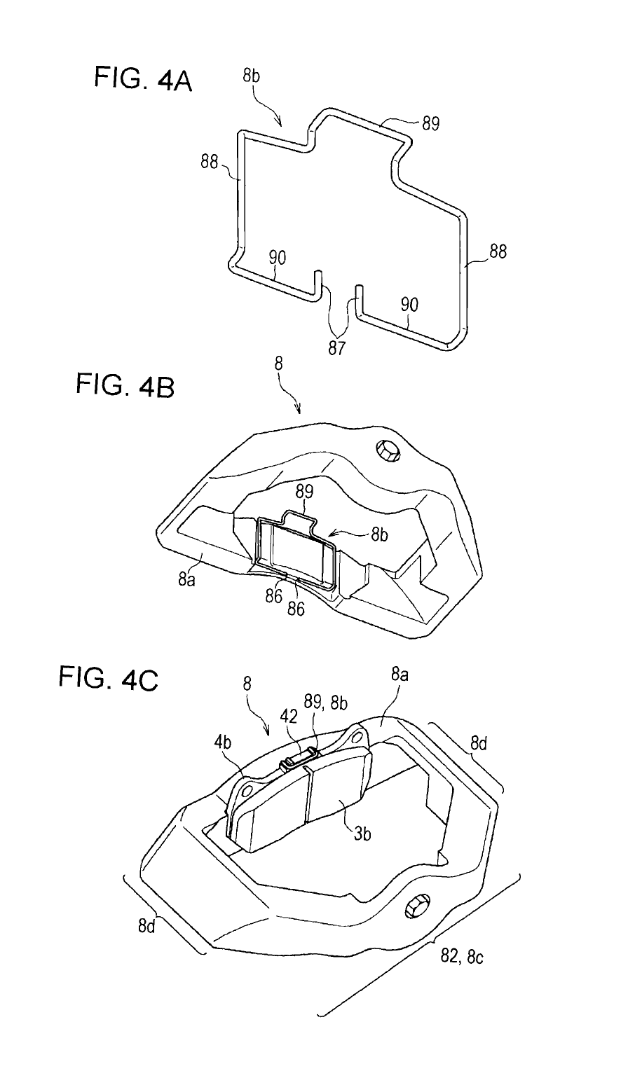

FIG. 4A illustrates a perspective view of the pad locking portion (wire spring) 8b. The wire spring 8b includes a pair of inserting portions 87 which are arranged extending in an approximately vertical direction; a pair of horizontal arm portions 90 which are connected to the inserting portions 87 and arranged extending in an approximately horizontal direction; a pair of vertical arm portions 88 which are connected to the horizontal arm portions 90 and arranged extending in an approximately vertical direction; and a contact portion 89 having both ends connected to the pair of vertical arm portions 88, respectively.

FIG. 4B illustrates a perspective view from below of the body frame 8 to which the wire spring 8b is attached. The lower surface in the middle of the pad connection portion 8a of the body frame 8 is provided with a pair of insertion holes 86. The pair of inserting portions 87 of the wire spring 8b are inserted in the pair of insertion holes 86.

FIG. 4C illustrates a perspective view from above of the body frame 8 to which the wire spring 8b, the pad plate 4b, and the outer pad 3b are attached. The contact portion 89 of the wire spring 8b is hooked in the projection portion 42 located at part of the upper outer end of the pad plate 4b. Thus, the pad connection portion 8a of the body frame 8 is suspended from the projection portion 42 of the pad plate 4b by the wire spring 8b, and thus is supported. Because of the suspension using the wire spring 8b, movement of the pad plate 4b in the axial direction is coordinated with the pad connection portion 8a. That is to say, when the pad connection portion 8a moves away from the pad plate 4b in the axial direction, the position of the inserting portions 87 illustrated in FIG. 4A relative to the contact portion 89 changes. The horizontal arm portions 90 are then twisted, the vertical arm portions 88 are bent, and thus a spring force (reaction force) occurs. The pad plate 4b and the pad connection portion 8a are pulled toward each other by the spring force, and consequently are moved in a coordinated manner. On the other hand, due to the suspension structure by the wire spring 8b, a play is created, and movement of the pad plate 4b in any direction other than the axial direction is not coordinated with the pad connection portion 8a. That is to say, even when the pad plate 4b moves more or less in a rotational direction about the axis of the disc rotor when brake is applied, the vertical arm portions 88 are merely inclined more or less, and the pad connection portion 8a is not moved (is not coordinated). In this mode, a play is created. The braking force becomes difficult to be transmitted from the pad plate 4b (outer pad 3b) to the pad connection portion 8a (body frame 8) because of this play. The wire spring 8b is provided with the pair inserting portions 87, the pair of horizontal arm portions 90, and the pair of vertical arm portions 88. By maintaining the balance on both sides of each pair, the body frame 8 can be held at a predetermined position, for example, held horizontally, or can be replaced even when the body frame 8 is once displaced. In the first embodiment, the wire spring 8b is used to connect the pad plate 4b (outer pad 3b) to the pad connection portion 8a of the body frame 8, however, the first embodiment is not limited to this. The pad plate 4b (outer pad 3b) may be fixed (connected) via a bolt, or may be fastened with a fit-in structure or an adhesion method to the pad connection portion 8a.

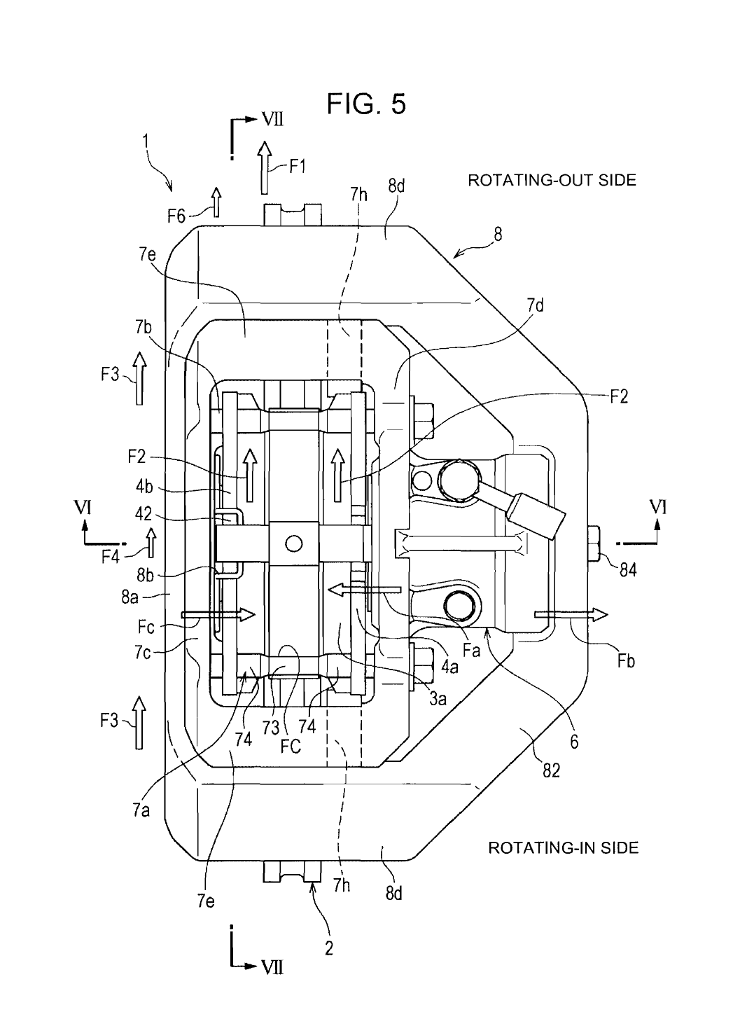

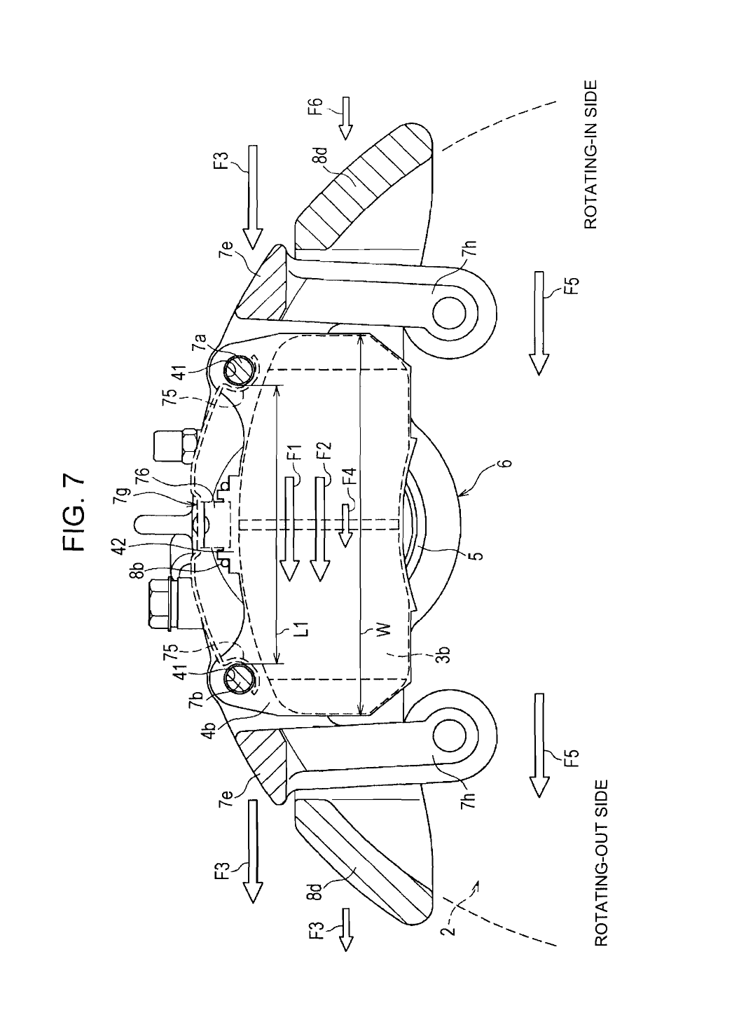

FIG. 5 illustrates a plan view of the disc brake device 1 according to the first embodiment of the present disclosure; FIG. 6 illustrates a cross-sectional view taken along the line VI-VI in FIG. 5; and FIG. 7 illustrates a cross-sectional view taken along the line VII-VII in FIG. 5. As illustrated in FIG. 6, when hydraulic fluid 6d is supplied to the cylinder 6 (hydraulic pressure chamber 6c), the first piston 5 and the second piston 81 (sliding portion 8c) of the body frame 8 are pressed in the respective outward directions of the axis of the cylinder so as to be pushed out from the cylinder 6. Accordingly, the first piston 5 presses the pad plate 4a (inner pad 3a) against the disc rotor by a force Fa, and the second piston 81 presses the connection bar 82 by a force Fb. The force Fa and the force Fb have the same magnitude and the opposite directions. The force Fb is transmitted from the connection bar 82 of the body frame 8 to the pad connection portion 8a. As illustrated in FIGS. 5 and 6, the pad connection portion 8a of the body frame 8 presses the pad plate 4b (outer pad 3b) against the disc rotor 2 by a force Fc (=Fb). Thus, the disc rotor 2 is pressed between the pair of pads 3a, 3b (pad plates 4a, 4b), and the brake is applied to the wheel. When the disc rotor 2 is pressed between the pair of pad plates 4a, 4b (pads 3a, 3b), the pad plates 4a, 4b push up the inclined pressing portions 76 of the return spring 7g by a force Fd while rubbing the surface of the inclined pressing portions 76. The return spring 7g stores a spring force Fe which is the reaction force of the force Fd. After brake is applied, the inclined pressing portion 76 of the return spring 7g is lowered by the spring force Fe, and the pair of pad plates 4a, 4b (pads 3a, 3b) are pushed away from each other by a force Ff which is a component of the spring force Fe, and thus the pads 3a, 3b are separated from the disc rotor 2. In addition, after brake is applied, rollback of the urging portions (sealing members) 6a, 6b also occurs, and thus the pair of pads 3a, 3b (pad plates 4a, 4b) are separated from the disc rotor 2.

In the disc brake device 1, when brake is applied, as illustrated in FIG. 5, the force F1 of the disc rotor 2 for rotational movement is transmitted to the inner pad 3a and the outer pad 3b while being dragged by the disc rotor 2 in rotation, and a braking force F2 is applied to the inner pad 3a and the outer pad 3b. The braking force F2 applied to the inner pad 3a and the outer pad 3b is transmitted to the slide pins 7a, 7b which support and suspend the inner pad 3a and the outer pad 3b, and thus a braking force F3 (≈F2) is applied to the slide pins 7a, 7b. The braking force F3 applied to the slide pins 7a, 7b is transmitted to the knuckle of the vehicle body, which is connected to the knuckle supported portion 7h via the frame structure constituted by the pair of first bridge portions 7e, the first tie bar 7c, and the second tie bar 7d of the caliper bracket 7, and thus a braking force F5 (≈F3≈F2) is applied to the knuckle. That is to say, the braking force F2 applied to the inner pad 3a and the outer pad 3b is transmitted via the slide pins 7a, 7b, and received by the caliper bracket 7, and the inner pad 3a and the outer pad 3b, to which a great force of the braking force F2 is applied, is substantially supported by the caliper bracket 7.

As illustrated in FIG. 6, the first tie bar 7c of the caliper bracket 7 is disposed above (direction away from the rotation axis of the disc rotor 2) and apart from the pad connection portion 8a of the body frame 8. As illustrated in FIG. 7, the pair of first bridge portions 7e of the caliper bracket 7 are disposed at inner positions in the circumferential direction of the disc rotor 2 with respect to the pair of second bridge portions 8d of the body frame 8. In this manner, the pad connection portion 8a of the body frame 8 and the second bridge portions 8d are disposed away from the first tie bar 7c and the first bridge portions 7e of the caliper bracket 7, and thus the braking force F3 applied to the caliper bracket 7 can be prevented from being transmitted and applied to the body frame 8.

As illustrated in FIGS. 5 and 7, the braking force F2 applied to the outer pad 3b (pad plate 4b) becomes difficult to be transmitted to the pad connection portion 8a suspended via the wire spring 8b, and thus a braking force F4 applied to the pad connection portion 8a is lower than the braking force F2 (F4<F2). Accordingly, a braking force F6 (=F4) which transmits through the body frame 8 (second bridge portions 8d) can be made low. As illustrated in FIG. 7, a distance L1 between the slide pins 7a and 7b is less than a width W of the outer pad 3b (inner pad 3a) (L1<W).

### Second Embodiment

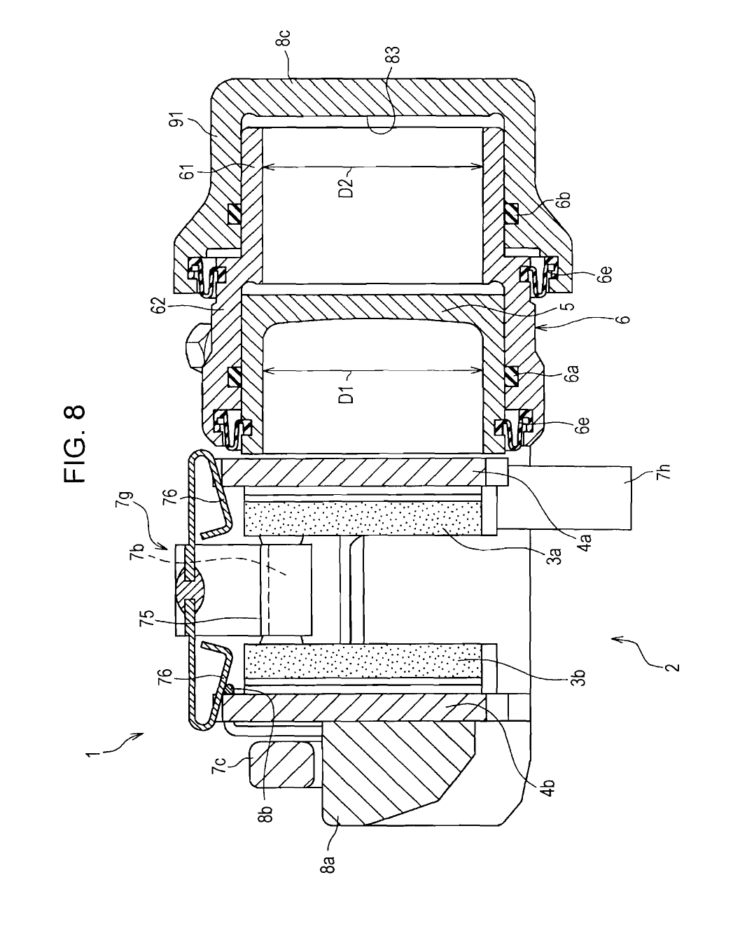

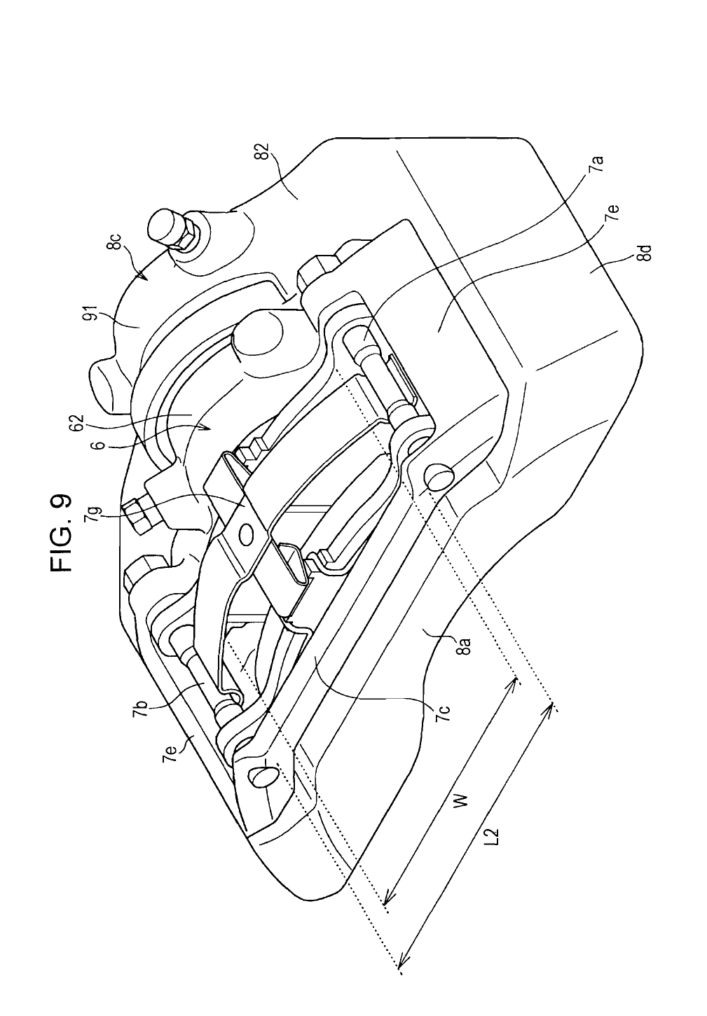

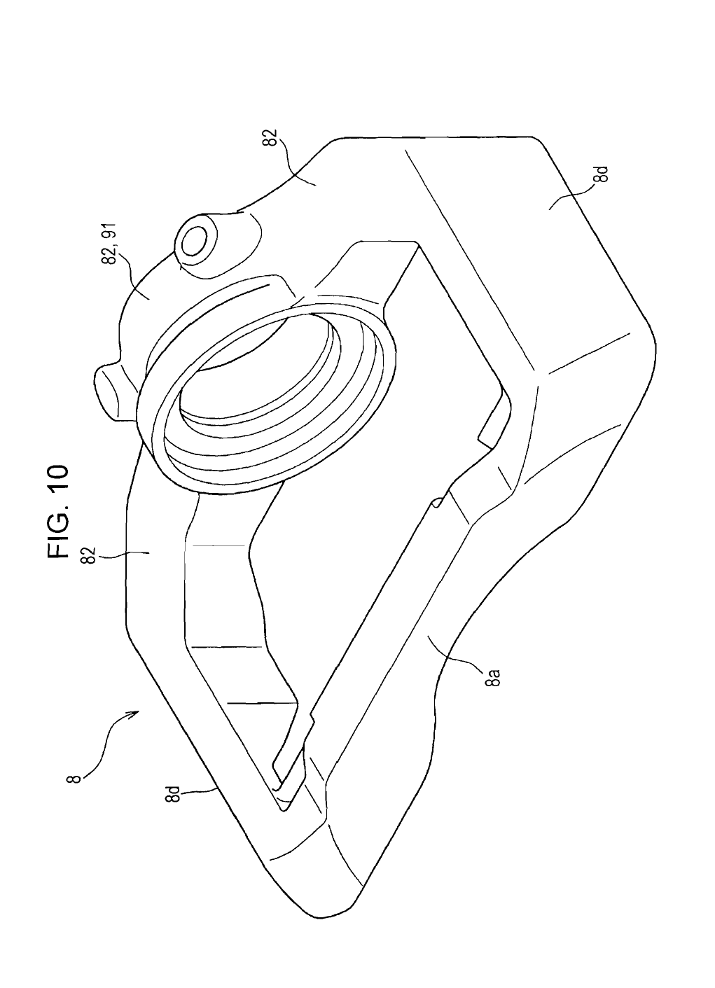

FIG. 8 illustrates a cross-sectional view of the disc brake device 1 according to a second embodiment of the present disclosure; and FIG. 9 illustrates a perspective view of the disc brake device 1. FIG. 10 illustrates a perspective view of the body frame 8. The second embodiment differs from the first embodiment in that the sliding portion 8c is supported on the outer circumference of the cylinder 6 slidably in the axial direction. Accordingly, the cylinder 6 has an inner cylinder 62 and a sleeve portion 61 for which the central axes are collinear. The first piston 5 which is slidable in the axial direction is housed inside the inner cylinder 62, and because the inner diameter D1 of the inner cylinder 62 is larger than the inner diameter of the sleeve portion 61, the first piston 5 may not be inserted into the sleeve portion 61, and is stopped when coming into contact with the sleeve portion 61. That is to say, the sleeve portion 61 serves as a stopper which limits a range in which the first piston 5 is slidable. An outer cylinder portion 91 of the sliding portion 8c is disposed outside the sleeve portion 61, the sliding portion 8c being slidable in the axial direction. The urging portion (sealing member) 6b such as an O-ring is provided between the outer cylinder portion 91 and the sleeve portion 61 so as to maintain liquid-tight sealing therebetween. The space inside the sleeve portion 61 serves as a hydraulic pressure chamber which is filled with hydraulic fluid. The hydraulic fluid is further supplied to the hydraulic pressure chamber, or discharged therefrom. The dust cover 6e is provided between an opening of the outer cylinder portion 91 and the cylinder 6 so that dust does not enter therebetween. The central axes of the outer cylinder portion 91 and the sleeve portion 61 are disposed so as to match each other. The outer cylinder portion 91 has a cylindrical shape with a bottom, and the bottom surface serves as the pressure receiving surface 83 which receives a hydraulic pressure from hydraulic fluid. The diameter of the pressure receiving surface 83, i.e., an inner diameter D2 of the outer cylinder portion 91 is approximately equal to the inner diameter D1 of the inner cylinder 62 (D2=D1). Because the pressure receiving surface 83 is stopped when coming into contact with the sleeve portion 61, the sleeve portion 61 is a stopper which limits a range in which the outer cylinder portion 91 is slidable. As illustrated in FIGS. 9 and 10, the outer cylinder portion 91 is part of the connection bar 82, and is connected to the second bridge portions 8d.

When hydraulic fluid is supplied to the hydraulic pressure chamber inside the sleeve portion 61, the first piston 5 and the pressure receiving surface 83 are separated from the sleeve portion 61 in the axial direction. Subsequently, brake can be applied to the disc rotor 2 similarly to the first embodiment. With the above configuration, the body frame 8 can be integrated (e.g., by integral casting), and therefore in contrast to the case where the second piston 81 is separately produced as in the first embodiment, the number of parts can be reduced, and the manufacturing cost can be reduced.

In the second embodiment, unlike the first embodiment, a distance L2 between the slide pins 7a and 7b is made longer than the width W of the outer pad 3b (inner pad 3a) (L2>W) as illustrated in FIG. 9. Accordingly, the slide pins 7a and 7b are disposed not above the outer pad 3b (inner pad 3a) but outside the outer pad 3b (inner pad 3a) at both sides thereof. Therefore, as illustrated in FIG. 9, the height of the lowest portion of the slide pins 7a and 7b is made lower than the height of the upper portion of the outer pad 3b (inner pad 3a), and the caliper bracket 7 is disposed at a lower position. A moment of rotation is applied to the pads 3a, 3b (pad plates 4a, 4b) when brake is applied. The moment of rotation is transmitted to the slide pins 7a and 7b, and the reaction force of the slide pins 7a and 7b for receiving the moment of rotation can be reduced as the distance L2 (L1 (see FIG. 7)) is increased. According to the second embodiment, the distance L2 can be increased. While embodiments have been described in detail, it should be appreciated that various modifications and/or variations may be made without departing from the scope or spirit of the subject matter of the present application.

We claim:

1. A disc brake device comprising:
a disc rotor rotating with a wheel;
a first pad and a second pad disposed opposite to each other with the disc rotor disposed therebetween;
a first piston for pressing the first pad against the disc rotor;
a cylinder supporting the first piston slidably in an axial direction; and
a body frame for pressing the second pad against the disc rotor,
wherein the body frame includes:
a pad connection portion connected to the second pad to push and pull the second pads; and
a sliding portion supported by the cylinder slidably in the axial direction such that a space is provided between the sliding portion and the first piston, the space serving as a hydraulic pressure chamber receiving hydraulic fluid,
wherein the disc brake device applies a brake to the wheel by pinching the disc rotor by the first and the second pads, and further comprises a caliper bracket supporting the first and the second pads movable in the axial direction while limiting a movement of the first and the second pads in any direction other than the axial direction, the caliper bracket being provided integrally with the cylinder and separated from the pad connection portion, and
wherein the support by the caliper bracket to the first and the second pads is provided at a first position located on a disc-rotor-rotating-in side of the disc brake device and at a second position located on a disc-rotor-rotating-out side of the disc brake device.

2. The disc brake device according to claim 1, further comprises a first pad plate and a second pad plate fix the first pad and the second pad, respectively,
wherein the caliper bracket includes:
a first slide pin and a second slide pin each penetrating through the first and the second pad plates in the axial direction at the first position and the second position, respectively,
a first bridge portion connecting to both ends of the first slide pin, and
a second bridge portion connecting to both ends of the second slide pin.

3. The disc brake device according to claim 2,
wherein the caliper bracket further includes a first tie bar connected to one end of the first slide pin and one end of the second slide pin, the one end of the first slide pin and the one end of the second slide pin being located opposite to the cylinder, and the first tie bar is separated from the pad connection portion.

4. The disc brake device according to claim 3,
wherein the caliper bracket further includes a second tie bar connected to the other end of the first slide pin and the other end of the second slide pin, the second tie bar being disposed on a cylinder side of the first and the second slide pins and supported by the cylinder, and
wherein the first tie bar and the second tie bar are connected via the first bridge portion and the second bridge portion.

5. The disc brake device according to claim 3,
wherein the body frame further includes a third bridge portion and a fourth bridge portion extending over the disc rotor and connecting the pad connection portion and the sliding portion, the pad connection portion is disposed at a position closer to an axis of the disc rotor than the first tie bar in a radial direction, and the third and the fourth bridge portions are disposed at outer positions compared to the first and the second bridge portions in a circumferential direction of the disc rotor with respect to the first and the second pads.

6. The disc brake device according to claim 1,
wherein the body frame further includes a third bridge portion and a fourth bridge portion extending over the disc rotor and connecting the pad connection portion and the sliding, and
the sliding portion includes:
a second piston supported by the cylinder slidably in the axial direction and faces the first piston, and
a connection portion connected to the second piston or provided integrally with the second piston, and also connected to the third and the fourth bridge portions.

7. The disc brake device according to claim 1,
wherein the sliding portion is supported on an outer circumference of the cylinder slidably in the axial direction.

8. The disc brake device according to claim 3,
wherein the body frame further includes a pad locking portion engaging a part of the second pad plate to the pad connection portion such that a movement of the second pad plate in the axial direction is coordinated with the pad connection portion, but a movement of the second pad plate in any direction other than the axial direction is not coordinated with the pad connection portion.

9. A disc brake device comprising:
a disc rotor rotating with a wheel;
a first pad and a second pad disposed opposite to each other with the disc rotor disposed therebetween;
a first piston for pressing the first pad against the disc rotor;
a cylinder supporting the first piston slidably in an axial direction; and
a body frame for pressing the second pad against the disc rotor,
wherein the disc brake device applies a brake to the wheel by supplying hydraulic fluid to a hydraulic pressure chamber demarcated by the cylinder and the first piston to pinch the disc rotor by the first and the second pads, and further comprises a caliper bracket supporting the first and the second pads movable in the axial direction while limiting a movement of the first and the second pads in any direction other than the axial direction, the caliper bracket being separated from the body frame and supported by a vehicle body, and
wherein the support by the caliper bracket to the first and the second pads is provided at a first position located on a disc-rotor-rotating-in side of the disc brake device and at a second position located on a disc-rotor-rotating-out side of the disc brake device.

10. The disc brake device according to claim 8, wherein the part of the second pad plate is an end of the second pad plate disposed at a top thereof.

11. The disc brake device according to claim 1, wherein the caliper bracket supports the first and the second pads movable in the axial direction so as not to limit a movement of the first and the second pads in the axial direction.

12. The disc brake device according to claim 9, wherein the caliper bracket supports the first and the second pads movable in the axial direction so as not to limit a movement of the first and the second pads in the axial direction.
